(19) United States
(12) Patent Application Publication
(10) Pub. No.: US 2015/0354345 A1
(43) Pub. Date: Dec. 10, 2015

(54) Methods and Systems for Analyzing Flow

(71) Applicant: Schlumberger Technology Corporation, Sugar Land, TX (US)

(72) Inventors: John Meier, Boston, MA (US); Elizabeth Smythe, Cambridge, MA (US); Matthew T. Sullivan, Westwood, MA (US); Shunsuke Fukagawa, Arlington, MA (US); Christopher Harrison, Auburndale, MA (US)

(21) Appl. No.: 14/730,189

(22) Filed: Jun. 3, 2015

Related U.S. Application Data
(60) Provisional application No. 62/008,975, filed on Jun. 6, 2014.

(51) Int. Cl. E21B 47/10; G01F 25/00; G01F 1/708

(52) U.S. Cl. CPC E21B 47/102; G01F 1/7086; G01F 25/0007

(57) ABSTRACT

Methods and systems for determining the presence and/or rate of a flow of a fluid sample include transmitting light through the fluid sample are disclosed. The methods comprise, applying a series of thermal pulses to the fluid sample, the series comprises a time interval between each thermal pulse, detecting transmitted light using a light detector; and determining at least one of (a) whether or not the fluid is flowing and (b) a flow rate of the fluid, based on an intensity of the transmitted light corresponding to at least one time interval.

### CROSS REFERENCE TO RELATED APPLICATIONS

This is a non-provisional application of co-pending U.S. Provisional Patent Application Ser. No. 62/008975 to John Meier, et al., filed on Jun. 6, 2014, and entitled “Methods and Systems for Analyzing How,” which is hereby incorporated in its entirety for all intents and purposes by this reference.

### TECHNICAL FIELD

This disclosure relates to fluid analysis, and more particularly to flow verification and/or flow rate measurement.

### BACKGROUND

Some fluidic applications utilize the presence of a fluid flow. One non-limiting example is microfluidic analysis. Some microfluidic platforms (in the context oil wells, for example) provide modules that allow captured fluid to be filtered and measured downhole with a set of microsensors. Measurements may include, for example, composition, density, viscosity, and PVT properties such as bubble point, dew point, and AOP (asphaltene onset pressure). Such measurements involve capturing a small sample of fluid and isolating it from a main tool flow line with valves. Such systems do not function properly when the sample fluid is not flowing through the microfluidic lines.

Moreover, some systems may utilize flow rates in analyzing the sample fluid.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Some examples provide a flow verification and/or flow rate measurement technique to ensure captured fluid is successfully flushing microfluidic lines to facilitate proper operation of the microfluidic platform. Some examples utilize hardware that is also utilized for determining bubble point and asphaltene onset pressure of the fluid.

Illustrative embodiments are directed to a method for analyzing a fluid sample. The method includes: transmitting light through the fluid sample; applying a series of thermal pulses to the fluid sample, wherein the series comprises a time interval between each thermal pulse; detecting transmitted light using a light detector; and determining, based on an intensity of the transmitted light corresponding to at least one time interval at least one of (a) whether or not the fluid is flowing and (b) a rate at which the fluid is flowing.

Various embodiments are also directed to a system for analyzing a fluid sample. The system includes: a light source configured to generate light that is transmitted through the fluid sample; a detector configured to detect light generated by the light source; a heating element configured to apply thermal pulses to the fluid sample; and a controller configured to determine, based on an intensity of the transmitted light corresponding to at least one time interval between thermal pulses, at least one of (a) whether or not the fluid sample is flowing and (b) a rate at which the fluid sample is flowing,

### BRIEF DESCRIPTION OF THE DRAWINGS

Those skilled in the art should more fully appreciate advantages of various embodiments of the present disclosure from the following “Description of Illustrative Embodiments,” discussed with reference to the drawings summarized immediately below.

FIG. 1 shows a wireline logging system at a well site in accordance with one embodiment of the present disclosure.

FIG. 2 shows a wireline tool in accordance with one embodiment of the present disclosure.

FIG. 3 shows a system for determining the presence and/or rate of flow of a fluid sample, with an entry valve and an exit valve in respective closed states.

FIG. 4 shows the system of FIG. 3 with the entry and exit valves in respective open states.

FIG. 5 shows the system of FIG. 3 with the entry valve in an open state and the exit valve in a closed state.

FIG. 6 shows the system of FIG. 3 during operation of a piston pump, with the entry valve in an open state and the exit valve in a closed state.

FIG. 7 shows components of the system of FIG. 3.

FIG. 8 shows another view of a subset of the components of FIG. 7.

FIG. 9 is a schematic illustration of a detection module of the system of FIG. 3.

FIG. 10A is a schematic illustration of the detection module of the system of FIG. 3 when light is transmitted though the fluid line.

FIG. 10B is a schematic illustration of the detection module of the system of FIG. 3 when light is transmitted through the fluid line and a thermal pulse affects optical intensity.

FIG. 10C is a schematic illustration of the detection module of the system of FIG. 3 when light is transmitted through the fluid line and a thermal pulse produces bubbles in the fluid.

FIG. 11A shows optical scattering signals when valves of the system of FIG. 3 are opened and closed.

FIG. 11B shows optical scattering signals when exit and entry valves of the system of FIG. 3 are opened.

FIGS. 12A and 12B show an optical scattering signal during periods of fluid flow and periods without fluid flow with a pulse width of 30 microseconds and a frequency of 1 Hz at 100W using the system of FIG. 3.

FIGS. 13A and 13B show an optical scattering signal during periods of fluid flow and periods without fluid flow with a pulse width of 40 microseconds and a frequency of 1 Hz at 100W using the system of FIG. 3.

FIG. 14 shows the results of in situ calibration for determination of flow rate of a fluid using the system of FIG. 3.

FIG. 15 shows a method for determining the presence or absence of a flow of a fluid.

FIG. 16 shows a method for determining a flow rate of a fluid.

FIG. 17 shows a method for performing in situ flow rate calibration.

### DETAILED DESCRIPTION

Illustrative embodiments of the disclosure are directed to methods and system for verifying flow and/or determining flow rate in a fluid system.

Some embodiments are incorporated into systems for determining bubble point pressure of a fluid sample, such as an oil sample. Such systems are described for example in U.S. patent application Ser. No. 13/800,896, filed on Mar. 13, 2013 and which is incorporated herein by reference in its entirety. Such systems may employ methods that include transmitting light through the fluid sample and detecting light that is transmitted through the fluid sample. The method further includes applying a series of thermal pulses, which may have a time interval therebetween, to the fluid sample. The behavior of the transmitted light during a time interval after each thermal pulse can be used to identify the presence of a flow and/or a rate of a flow.

In some examples, a relative light signal is determined using (i) an intensity of the transmitted light corresponding to a pulse and (ii) a baseline intensity of the transmitted light corresponding to a time interval.

Some example embodiments of the present disclosure provide a method to measure flow rate in a system having an optical sensor and a pulsed thermal source (e.g., any of the systems described in U.S. patent application Ser. No. 13/800,896).

Some embodiments of the present disclosure are implemented in connection with a diagnostic system (e.g., a wireline logging system) at a well site.

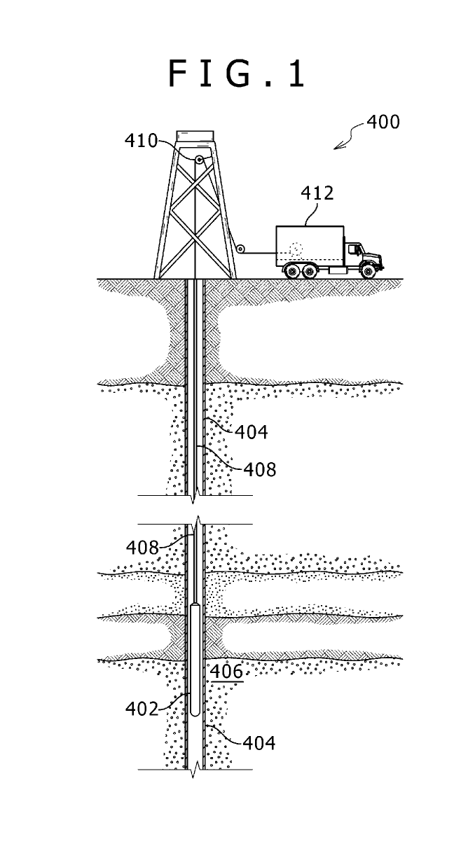

FIG. 1 shows an example of a wireline logging system 400 at a well site. Such a wireline logging system 400 can be used to implement a measurement of bubble point pressure, as described in U.S. patent application Ser. No. 13/800,896, as well as many other analyses of obtained sample fluids. In this example, a wireline tool 402 is lowered into a borehole 404 that traverses a formation 406 using a cable 408 and a winch 410. The wireline tool 402 is lowered down into the borehole 404 and makes a number of measurements of the adjacent formation 406 at a plurality of sampling locations along the borehole 404. The data from these measurements is communicated through the cable 408 to surface equipment 412, which may include a computer system for storing and processing the data obtained by the wireline tool 402. In this case, the surface equipment 412 includes a truck that supports the wireline tool 402. In other embodiments, however, the surface equipment may be located within a cabin, an off-shore platform, or any other suitable location.

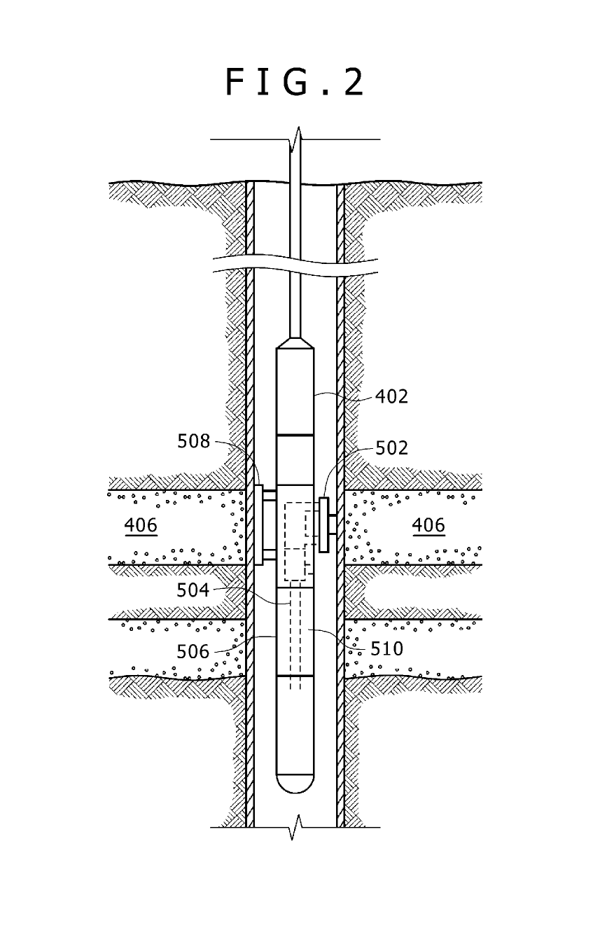

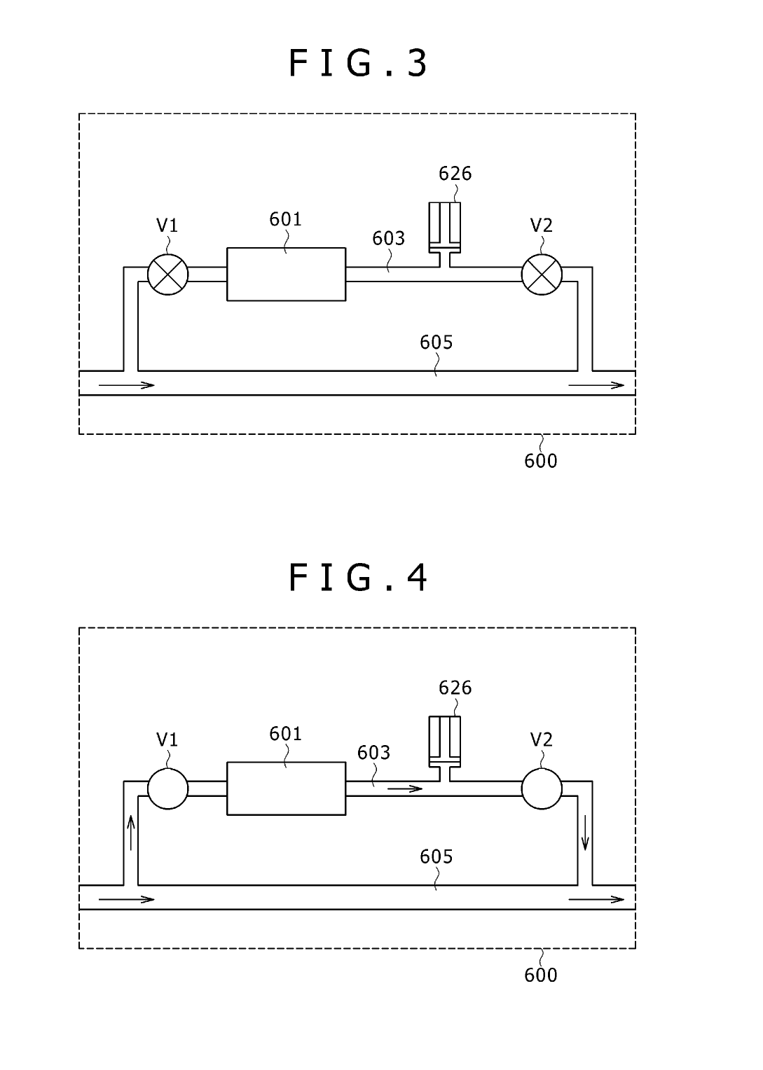

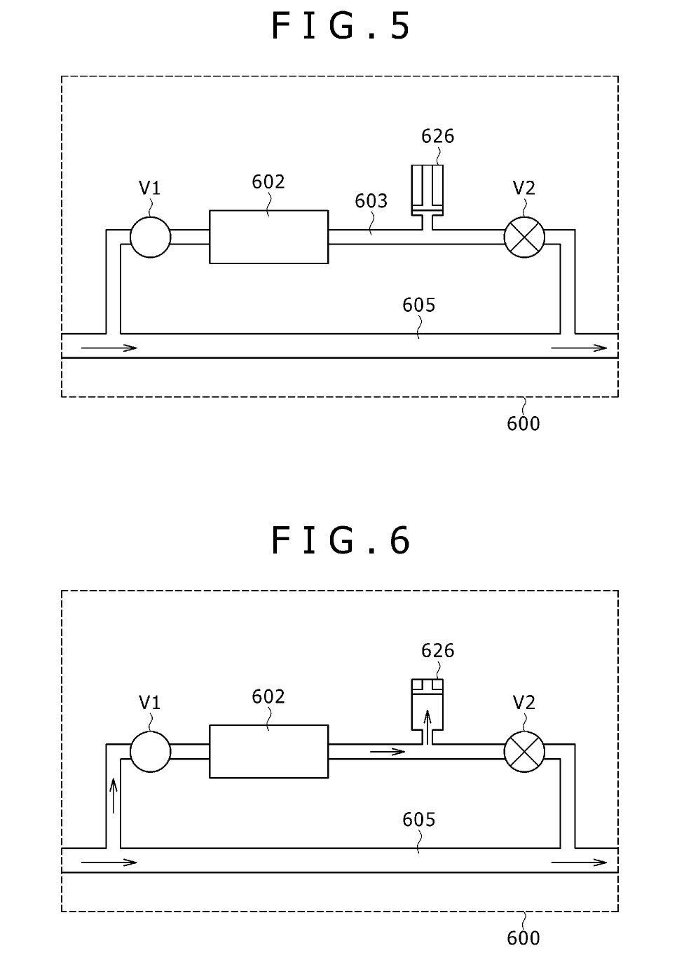

FIG. 2 shows a more detailed view of the wireline tool 402. The wireline tool 402 includes a selectively extendable fluid admitting assembly (e.g., probe) 502. This assembly 502 extends into the formation 406 and withdraws formation fluid from the formation 406 (e.g., samples the formation). The fluid flows through the assembly 502 and into a flow line 504 within a housing 506 of the tool 402. A pump can be used to withdraw the formation fluid from the formation 406 and pass the fluid through the flow line 504. The wireline tool 402 may also include a selectively extendable tool anchoring member 508 that is arranged to press the probe 502 assembly against the formation 406. The wireline tool 402 also includes a fluid analyzer module 510 for analyzing at least a portion of the fluid in the flow line 504. In this example, the fluid analyzer module 510 includes a system 600 (illustrated in FIGS. 3 to 6) for determining the presence and/or rate of flow of a fluid sample. The system 600 of this example is also configured to determine bubble point pressure of a fluid sample as described in U.S. patent application Ser. No. 13/800,896. It should be understood, however, that other examples may be configured for determining bubble point pressure.

FIGS. 3 to 6 show schematic illustrations of the system 600 which is part of a test platform. The flow verification or flow rate measurement can be made in a cell 601. A giston (micropiston) 626 can be used to draw fluids into the microfluidic lines at a known flow rate with an exit valve V2 closed and the entry valve V1 open. The μPiston 626 provides the ability to perform in situ flow rate calibrations for implementation of the system as a quantitative flow meter. In some examples, the system may be configured as a flow verification mechanism without quantitative flow measurements.

The cell 601 in the illustrated example is a phase change cell that contains the pulsed thermal source and the optical measurement. Flow is driven through the microfluidic lines 603 by pressure driven flow when both V1 and V2 are open due to a 20 psi pressure drop across a main flow line. The μPiston can also be used to draw fluid into the microfluidics at known rates with V1 open and V2 closed, giving the ability to perform an in situ calibration.

The optical scattering response to a fixed thermal pulse may vary between fluids and may be a function of flow rate (as shown here and the physical basis of this measurement), fluid composition, pressure, and temperature. Thus, in some examples, it may be desirable to provide in situ calibration ability when using the system 600 as a quantitative flow meter.

The magnitude of the heat pulse may also affect the optical scattering response of the fluid as well. In some examples, the system 600 is configured to provide a 100 W pulse with a pulse width of between, for example, 1 μs and 100 μs, e.g., 5 μs, 10 μs, 15 μs, 20 μs, 25 μs, 30 μs, 35 μs, 40 μs, 45 μs, 50 μs, 55 μs, 60 μs, 65 μs, 70 μs, 75 μs, 80 μs, 85 μs, 90 μs, 95 μs, or 100 μs. The pulses may have any suitable frequency. In some examples, the frequency may be on the order of 1 Hz.

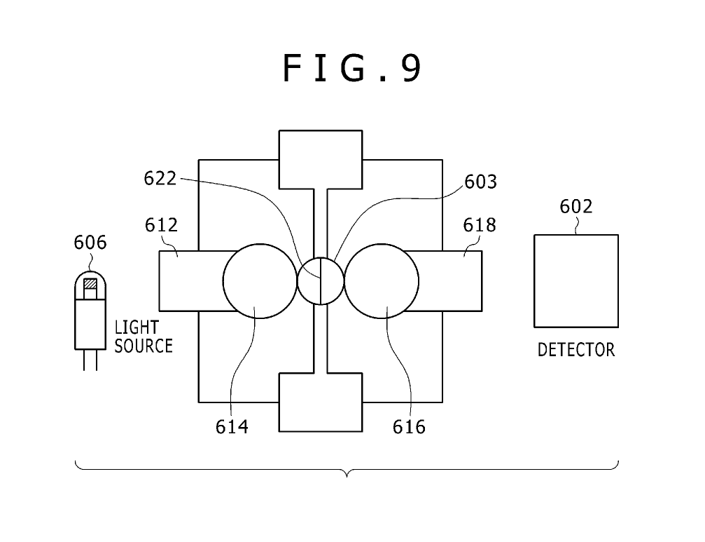

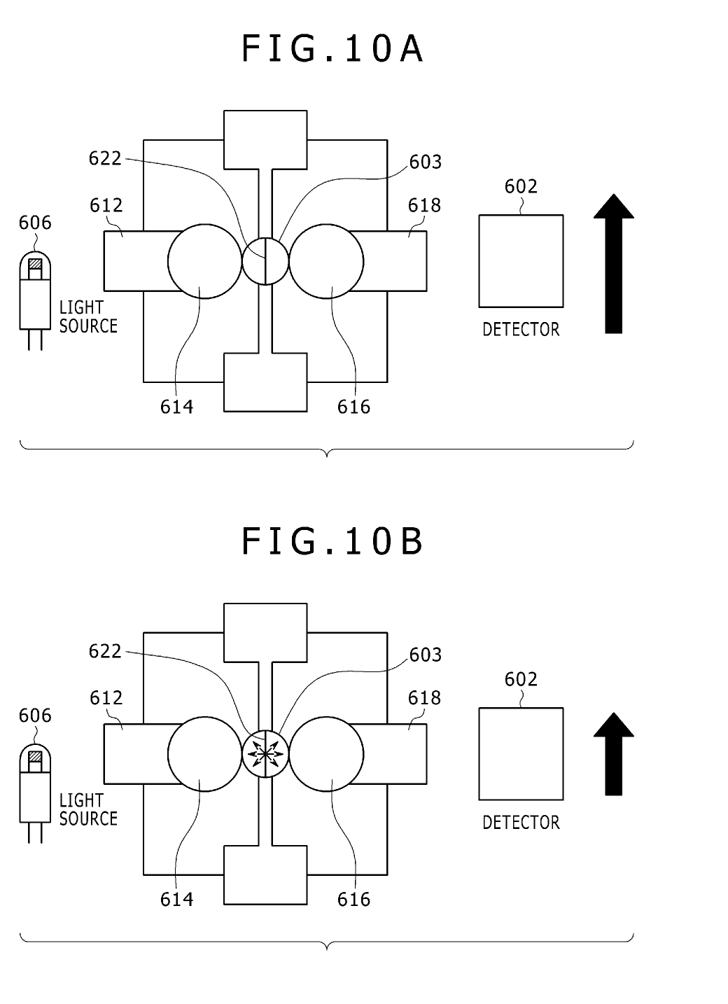

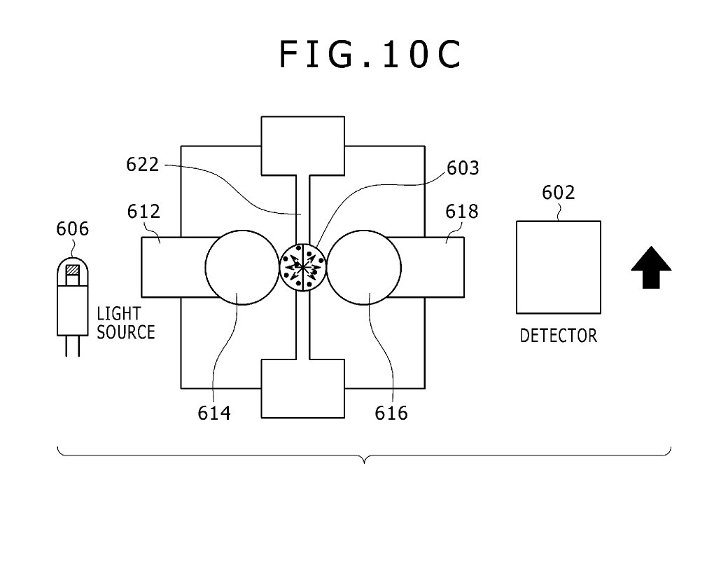

FIG. 9 shows a schematic of components of the analysis cell 602 of the system 600, where the flow rate and/or flow verification measurements take place. FIGS. 10A to 10C schematically illustrate the change in the fluid's index of refraction and optical scattering as the heat pulse is generated. It should be noted that if too much heat is added to the fluid, bubbles can form on the pulsed wire, dramatically increasing the optical scattering through the cell, as indicated in FIG. 10C. In some examples, this step change in optical scattering due to bubble nucleation is avoided in the flow rate and/or verification measurement. In some instances, the “mirage effect” and/or the presence of bubbles can cause the detected optical scattering to decrease in magnitude rather than increase as would be expected from simple index of refraction gradients. In some examples, the system 600 is calibrated to account for bubble formation and such effects.

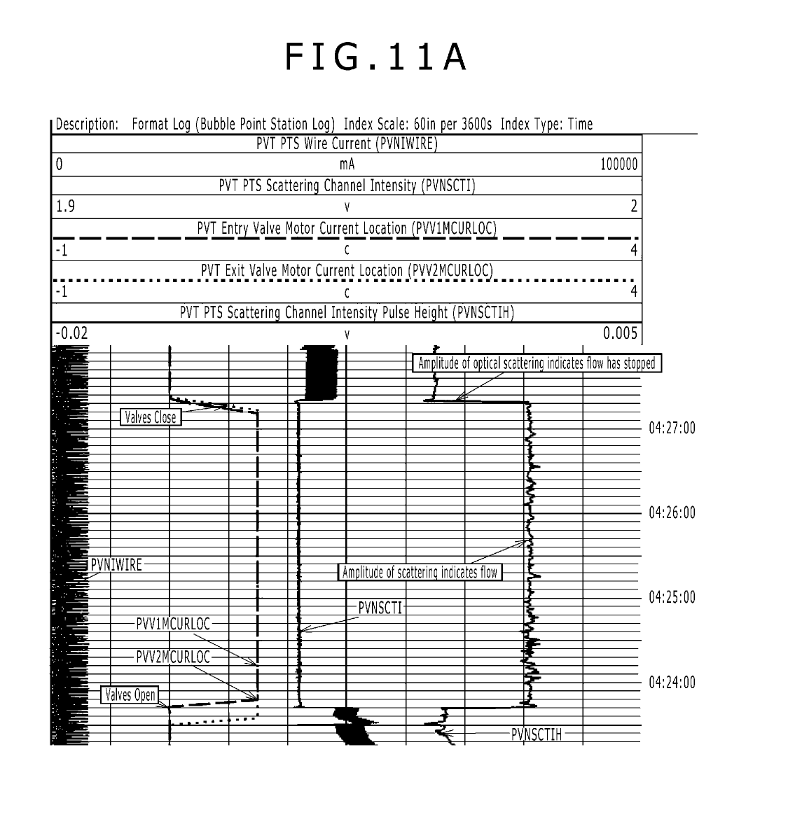

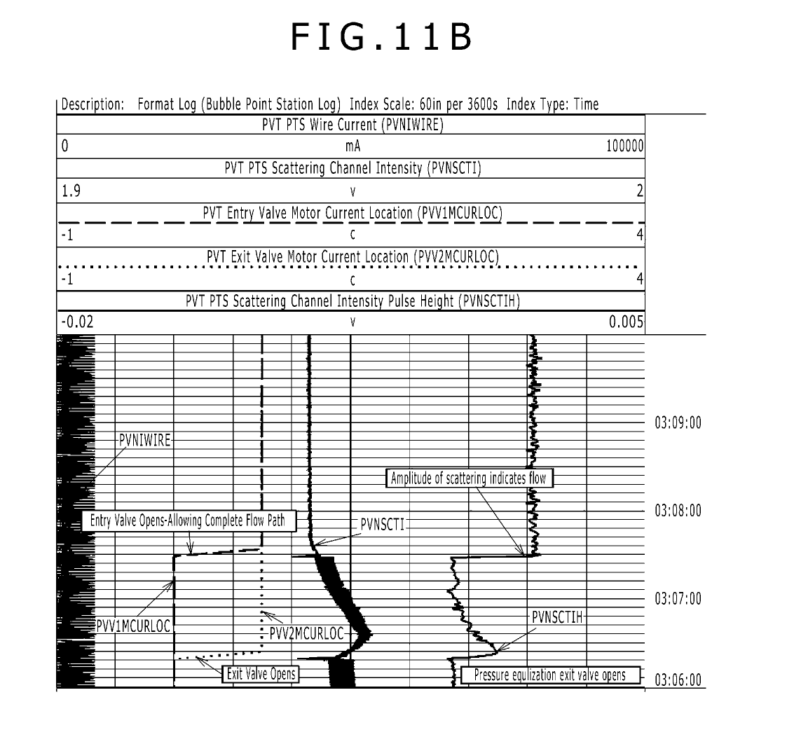

FIGS. 11A and 11B show two examples where a flow verification method described herein is conducted using the system 600. In these scenarios the platform shown, for example, in FIGS. 3 to 5 is circulated with flow through the main flow line 605 constantly using a pump. Valves V1 and V2 are opened, as illustrated in FIG. 4, to refresh the fluid sample in the microfluidic components 603, and then Valves V1 and V2 are closed, as illustrated in FIG. 3, to perform a bubble point measurement as described in U.S. patent application Ser. No. 13/800,896.

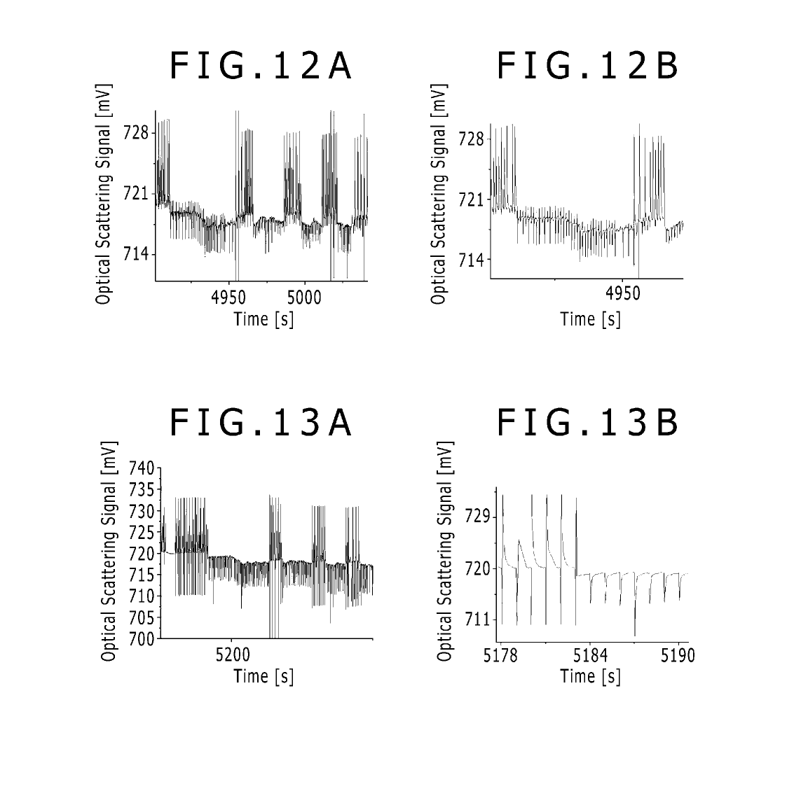

The in situ calibration in this example is conducted using a methane-heptane mixture as a test fluid. It should be understood that the optical scattering response of the fluid may be dependent, in addition to the fluid properties, the magnitude and rate of heat input in each pulse. FIGS. 12A, 12B, 13A, 13B, and 14 show some of the results from the calibration process.

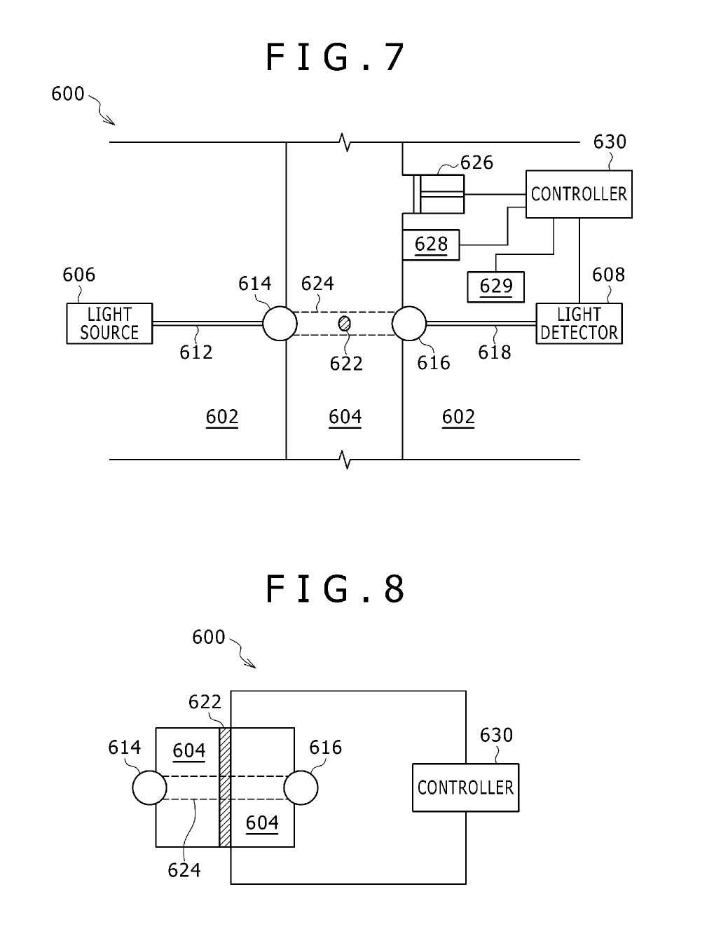

FIGS. 7 and 8 show additional views of the system 600. The system 600 includes a housing 602 that surrounds a detection chamber 604 for at least partially containing the fluid sample in some embodiments. In various embodiments, the housing 602 is formed from a metal material, such as aluminum. In some embodiments, the detection chamber 604 is a channel that receives a fluid sample that is extracted from the flow line 504 of the wireline tool 402. In yet further embodiments, the channel may be a microfluidic channel that has a diameter of less than 1 mm

As shown in FIGS. 7 and 8, the system 600 also includes the light source 606 for generating light that passes through the fluid sample and the light detector 608 for detecting transmitted light. The light can be of a variety of different wavelengths and can include, for example, visible light, infrared light, and/or ultraviolet light. In the specific embodiment shown in FIG. 7, the light source 606 is a tungsten halogen lamp that generates light and provides the light to a first optical fiber 612. A first ball lens 614 serves as both a window preventing outflow of the fluid sample and a lens that collimates the light from the optical fiber 612 into the detection chamber 604. The system 600 also includes a second ball lens 616 that serves as both a window preventing outflow and a lens that focuses the light signal from the detection chamber onto a second optical fiber 618. Although ball lenses 614 and 616 are provided in the illustrated example, it should be understood than any suitable type of lens may be provided.

The second optical fiber 618 provides the transmitted light to a light detector 608, such as, for example, a photodiode. The light detector 608 translates the transmitted light into a transmitted light signal that is representative of the intensity of the transmitted light.

FIGS. 7 and 8 further show the heating element 622 for applying the thermal pulses to the fluid sample. The heating element 622 is at least partially disposed within the detection chamber 604 so that it can apply thermal energy to the fluid sample. In some embodiments, the heating element 622 is a wire that passes orthogonally between the first ball lens 614 and the second ball lens 616 (e.g., passes through a collimated light path 624 between the two lenses 614, 616). The wire 622 may have any suitable diameter and can be made of, for example, nickel, chromium, iridium, palladium, and/or platinum. In some embodiments, the wire may be a combination of 80 percent Nickel and 20 percent Chromium (Nichrome80). In some non-limiting examples the diameter of the heating element wire 622 be selected from a range from 5 μm to 100 μm, e.g., 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, or 100 μm. Moreover, although a single wire 622 is provided, it should be understood that some examples utilize multiple wires 622 which may be the same or different from each other.

A pulsed electric current is applied to the wire 622. The pulsed current will create thermal energy within the wire 622 that will conduct into the fluid that surrounds the wire. In this manner, the wire 622 generates thermal pulses that enter the fluid sample and raise the temperature of the fluid sample. To optimize the performance of the system 600, the layout of the system 600 may be selected so that the light incident to the detection chamber 604 passes through the detection chamber with maximum optical efficiency and uniformly illuminates a volume around the wire 622 where the thermal optical effects take place. To this end, in some examples, fiber-to-lens spacing and location of the wire within the system may be selected for optimization for particular applications.

In some examples, while the local temperature gradient at the heat source is very high, the total amount of heat added to the fluid is insignificant relative to the thermal mass of the fluid and sensor housing, never raising the temperature of the bulk fluid greater than 0.01C. This is a result of the miniaturization of the heat source and optical detection hardware as well as the pulse frequency and duty cycle of the heat source. In other words, the measurement can be made without increasing the temperature of the bulk fluid sample greater than 0.01C above the original bulk fluid sample temperature.

In some embodiments, the system 600 also includes a pressure unit 626 for changing the pressure within the fluid sample and a pressure sensor 628 that monitors the pressure of the fluid sample. In one specific embodiment, the pressure unit 626 is a piston that is in communication with the detection chamber 604 and that expands the volume of the fluid sample to decrease the pressure of the sample within the detection chamber. A pressure sensor 628 is used to monitor the actual pressure within the fluid sample. The pressure sensor 628 can be, for example, a strain gauge or a resonating pressure gauge.

The system 600 may also include a temperature detector 629, such as, for example, a resistive temperature detector (RTD), that is in thermal communication with the fluid sample and measures the temperature of the fluid sample. In some embodiments, the temperature detector 629 is in thermal contact with the housing 602 and is configured to measure the temperature of the fluid sample within the detection chamber 604.

The system 600 also includes a controller 630 for controlling the system 600 and processing signals that are received from various components within the system. In particular, in various embodiments, the controller 630 provides the pulsed electric current to the wire 622 so that the series of thermal pulses is applied to the fluid sample. To this end, the controller 630 may include a power supply and an oscillator circuit. The controller 630 may also receive the transmitted light signal that is representative of the intensity of the transmitted light from the light detector 608. The controller 630 may also maintain timing (e.g., synchronization) between the transmitted light signal from the light detector 608 and the pulsed electric current provided to the wire 622 so that corresponding portions between the transmitted light signal and pulsed electric current can be identified. In an asynchronous embodiment, the controller 630 may sample the transmitted light signal at a high sampling rate, such as 100 Hz. In some embodiments, the controller 630 samples the transmitted light signal at a frequency of at least 25 Hz. The controller 630 may use the transmitted light signal to determine a relative light signal. A process for determining a relative light signal is further described below. Furthermore, the controller 630 can also be in electronic communication with the pressure unit 626 and the pressure sensor 628. The controller 630 can modify the pressure within the detection chamber 604 by controlling the pressure unit 626 and also monitor the actual pressure within the sample by interpreting an output pressure signal from the pressure sensor 628. In some embodiments, the controller samples the output pressure signal at a sampling rate of between 10 Hz and 60 Hz.

Illustrative embodiments of the system 600 are not limited to the embodiment shown in FIGS. 7 and 8. For example, in some embodiments, a flat planar window can serve to prevent outflow of the fluid and a ball lens can be positioned behind the planar window. In another illustrative embodiment, a light emitting diode (LED) is used in place of the tungsten halogen lamp.

FIG. 9 shows a schematic illustration of the cell 601. The fine wire 622 runs vertically in the schematic through the high pressure fluid flowing through the fluidic line 603. There are two optical windows comprised of respective lenses 614 and 616 on either side of the sample. Light from an optical source, such as, for example, an incandescent light bulb, is typically directed through one window of the optical cell, collected by the second optical window and directed onto a detector.

FIG. 10A shows light transmitted through the cell 601 filled with fluid (in the fluidic line 603 with thermal pulse off, resulting in a strong signal intensity as denoted by the height of the block arrow to the right of the detector 602.

FIG. 10B illustrates a situation where the thermal pulse (illustrated by small arrows extending away from the wire 622 inside the fluidic line or channel 603) is applied, creating a small decrease in optical intensity, denoted by the block arrow to the right of the detector 602, which as illustrated is smaller in magnitude than the corresponding arrow of FIG. 10A. The incident beam is lensed away from the detector 602 due to the local variation in index of refraction created by the heat pulse (which may be described as a “mirage effect”), lowering the measured signal. In this case, the pressure is far away from the bubble point pressure and so no bubbles are produced.

FIG. 10C illustrates a situation where the thermal pulse is applied in a sample in a manner (e.g., high pulse magnitude and/or high pulse length) that produces gas bubbles, which are illustrated as small circles within the fluidic line 603. The gas bubbles greatly scatter the light, leading to a decreased signal, as illustrated by the magnitude of the block arrow to the right of the detector 602. In some instances the mirage effect and/or the presence of bubbles can cause the detected optical signal to increase in magnitude.

FIG. 11A illustrates a scenario where a pressure gradient exists across the inlet and outlet of the microfluidic loop in the platform. Pressure driven flow will only occur if both the inlet and exit valves V1 and V2 to the microfluidic loop are open. The signal curve PVNSCTI is a measure of the optical scattering through the Phase Transition Cell. The curve PVNSCTIH is a measure (in this example, the inverse) of the amplitude of this optical scattering. The amplitude of the optical scattering clearly decreases when fluid starts flowing in the microfluidic loop as the valves are opened, and the magnitude of curve PVNSCTIH can be directly correlated to flow rate using the appropriate calibration. When the valves close, the amplitude of the optical disturbance returns to its previous value for no flow. In this example, the valves are opened after performing a bubble point measurement on a methane-heptane mixture (selected as a testing fluid for purposes of this example), so some pressure equilibration takes place as the valves are opened.

FIG. 11B shows an example in which when the exit valve V2 opens, the pressure between the microfluidics 603 and the main flow line 605 is equalized. There may be a small amount of fluid motion due to compressibility and the pressure equalization, but no flow occurs until the entry valve V1 is also opened. Relying solely on pressure measurements and pressure differentials in this case could lead to a false confirmation of flow before valve V1 is opened.

FIG. 11C shows an example in which the flow can be seen to start and stop with the opening and closing of the microfluidic valves V1 and V2.

FIGS. 12A and 12B show a pulse width of 30 μs and frequency of 1 Hz at 100W. In FIG. 12A, fluid flow is indicated by the sections of time with decreased optical scattering amplitude. In FIG. 12B, the time axis shows a shorter range to highlight the characteristic response of each individual pulse with and without flow. In FIG. 12B, it can be seen that not only the amplitude of the optical scattering changes with flow rate, but also the characteristic response. With no flow, the optical scattering response here is seen to increase from the baseline value, but with flow, the scattering appears to first increase and then decrease.

FIGS. 13A and 13B show a pulse width of 40 μs and frequency of 1 Hz at 100W. In FIG. 13A, fluid flow is indicated by the sections of time with decreased optical scattering amplitude. In FIG. 13B, the time axis shows a shorter range to highlight the characteristic response of each individual pulse with and without flow. In FIG. 13B, it can be seen that not only the amplitude of the optical scattering changes with flow rate, but also the characteristic response. With no flow, the optical scattering response in this example is seen to increase and then decrease from the baseline value for each individual pulse, but with flow, the scattering only decreases.

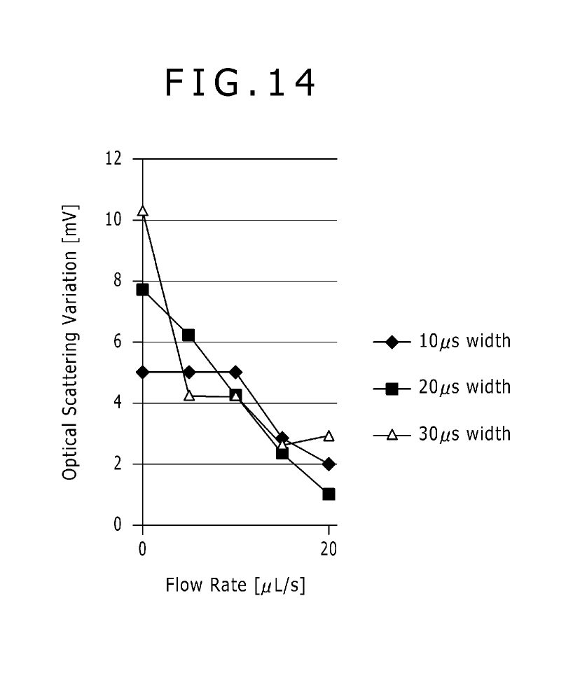

FIG. 14 shows the results of an in situ calibration. For the particular fluid of this example, the optical scattering variation is nearly linear with flow rate in the region of interest for a 100 W pulse width of 20 μs at 1 Hz. Thus, in this example, the linearity provided by the 100 W pulse width of 20 μs at 1 Hz may simplify the flow rate calculation. It should be understood, however, that other values may be utilized, including those that exhibit non-linear results (e.g., thel0 μs and 30 μs pulse widths illustrated in FIG. 14).

In some embodiments, a relative light signal is used to analyze the flow of the sample fluid. The relative light signal is determined using (i) the intensity of the transmitted light corresponding to a pulse and (ii) the baseline intensity of the transmitted light corresponding to a time interval. In particular, a baseline intensity of the transmitted light corresponding to an end portion of the time interval is used (or a plurality of end portions). The controller maintains timing (e.g., synchronization) between the transmitted light signal from the detector and the pulsed electric current provided to the wire so that corresponding portions between the transmitted light signal and pulsed electric current can be identified. In various embodiments, the baseline intensity portion corresponds to the end portion of the time interval, which occurs at the end of the time interval and before the next thermal pulse is applied. In such embodiments, the baseline intensity may be obtained at the end portion of the time interval so that the intensity of the transmitted light signal has time to recover from the prior thermal pulse. In other embodiments, if the time interval is sufficiently long, the baseline intensity can be obtained at a different portion of the time interval (e.g., a central portion). The intensity of the transmitted light corresponding to a pulse can be obtained as the current pulse is being applied. Also, in various embodiments, the intensity of the transmitted light corresponding to a pulse is acquired shortly after the current pulse is applied (e.g., 10 milliseconds after the pulse 904 is applied). The acquisition can be delayed due to the time lag associated with thermal energy entering the fluid sample from the heating element.

As explained above, the relative light signal can be used to analyze the flow. In some examples, the relative light signal can be calculated according to the following equation.

$$Relative Light Signal ( t ) = \frac{I ( Baseline ) - I ( t )}{I ( Baseline )} , \qquad Eq . 1$$

where I(t) is the intensity of the transmitted light at time (t) and I(Baseline) is the baseline intensity of the transmitted light corresponding to the time interval. In one embodiment, the baseline intensity of the transmitted light is obtained from a single light intensity value that corresponds to a single time interval (e.g., a single end portion). For example, the single light intensity value corresponds to an end portion of a time interval that appears immediately after the thermal pulse is applied. In other embodiments, the baseline intensity of the transmitted light is obtained from a plurality of light intensity values that each correspond to a time interval. For example, the baseline intensity of the transmitted light signal can be obtained by averaging two light intensity values. The first light intensity value corresponds to an end portion of a time interval that appears immediately before the thermal pulse is applied, while the second light intensity value corresponds to an end portion of a time interval that appears immediately after the thermal pulse is applied. In yet another example, more than two light intensity values are used to determine the baseline intensity of the transmitted signal.

A change in the magnitude in the relative light signal may be used to identify the presence/absence of flow and/or flow rate.

Equation 1 is one example of a relationship that can be used to determine a relative light signal. Other relationships can also be used to determine the relative light signal. For example, in one embodiment, the relative light signal is determined using an absolute value of the difference between (i) the baseline intensity of the transmitted light corresponding to the time interval and (ii) the intensity of the transmitted light at time (t), as shown in the following equation.

$$Relative Light Signal ( t ) = \frac{\vert I ( Baseline - I ( t ) ) \vert}{I ( Baseline )} , \qquad Eq . 2$$

In some embodiments, the relative light signal is determined using a ratio of the baseline intensity of the transmitted light corresponding to the time interval and the intensity of the transmitted light at time (t), as shown in the following equation.

$$Relative Light Signal ( t ) = \frac{I ( Baseline )}{I ( t )} , \qquad Eq . 3$$

In a further embodiment, the relative light signal is determined by subtracting the intensity of the transmitted light from the intensity of the transmitted light at time (t), as shown in the following equation.

Relative Light Signal (t)=I(Baseline)−I(t), Eq. 4

Other relationships that use the baseline intensity of the transmitted light corresponding to the time interval to determine a relative light signal are also within the scope of the present disclosure.

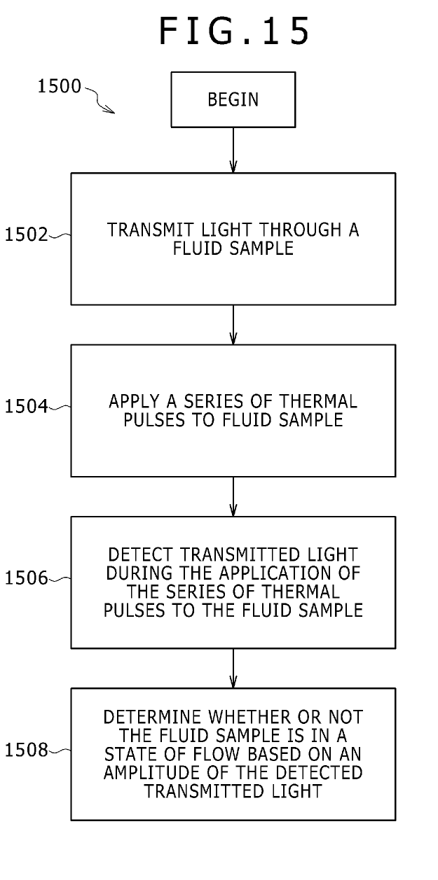

Various embodiments of the present disclosure are also directed to methods for determining whether or not a fluid sample is in a state of flow. The methods may be implemented by the systems described above (e.g., system 600). FIG. 15 shows one example of a method 1500 for determining the presence or absence of a flow of a fluid sample. The method 1500 includes transmitting light through the fluid sample 1502, applying a series of thermal pulses to the fluid sample 1504, detecting transmitted light after application of the series of thermal pulses to the fluid sample 1506, and determining whether or not the fluid sample is in a state of flow based on an amplitude of the detected transmitted light 1508.

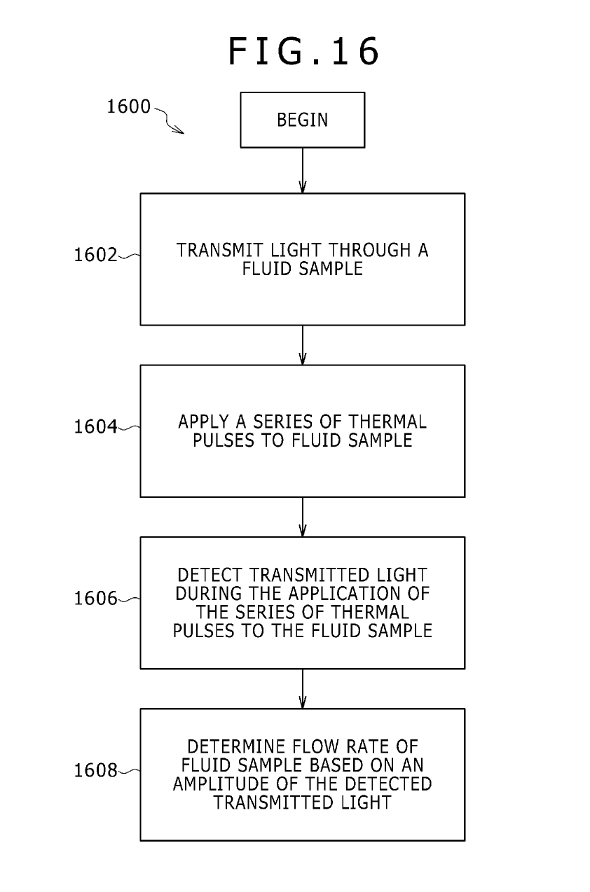

Some embodiments include methods for determining a flow rate of a fluid sample. The methods may be implemented by the systems described above (e.g., system 600). FIG. 16 shows one example of a method 1600 for determining the flow rate for a fluid sample. The method 1600 includes transmitting light through the fluid sample 1602, applying a series of thermal pulses to the fluid sample 1604, detecting transmitted light after application of the series of thermal pulses to the fluid sample 1606, and determining a flow rate based on an amplitude of the detected transmitted light 1608.

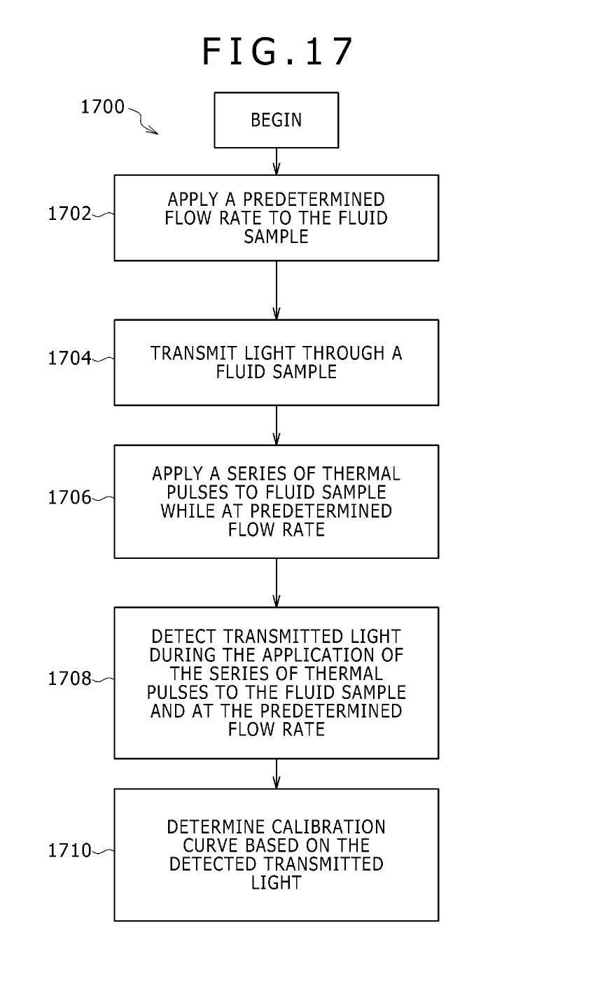

Some embodiments include methods for performing in situ flow rate calibration for determining a flow rate of a fluid sample. The methods may be implemented by the systems described above (e.g., system 600). FIG. 17 shows one example of a method 1700 for in situ calibration for measurement of flow rate of a fluid sample. The method 1700 includes applying a predetermined flow rate to the fluid sample 1702, transmitting light through the fluid sample 1704, applying a series of thermal pulses to the fluid sample 1706, detecting transmitted light during application of the series of thermal pulses (e.g., after each of the individual pulses of the series) to the fluid sample and at the predetermined flow rate 1708, and determining a calibration curve based on the detected transmitted light. The method 1700 may include detecting the light at different predetermined flow rates to facilitate generation of the calibration curve.

The processes described herein, including, for example, (1) determining whether or not a sample fluid is flowing, (2) determining a flow rate of a sample fluid, (3) performing in situ calibration for flow rate measurement, (4) providing a pulsed electric current to a wire, (5) interpreting an output pressure signal from a pressure sensor, (6) controlling a pressure unit, (7) receiving a transmitted light signal from a detector, (8) determining a relative light signal, (9) identifying a change within a relative light signal, (10) identifying a change within a transmitted light signal, (11) analyzing amplitudes of a transmitted light signal, (12) obtaining light intensity values corresponding to portions of a pulsed electric current, (13) determining bubble point pressure of a fluid sample, and/or (14) determining asphaltene onset pressure of a fluid sample, may be performed by the controller.

In some embodiments, the controller is located within the borehole tool along with the system for determining bubble point pressure. In such an embodiment, processes 1-10 can be performed within the borehole tool. In another embodiment, the controller is located at the surface as part of the surface equipment (e.g., the truck 412 in FIG. 1) and some or all of processes (1)-(14), or any other processes described herein, are performed at the surface by the surface equipment. In some embodiments, a first controller is included within the borehole tool and a second controller is located at the surface as part of the surface equipment. In some embodiments, the processes (1)-(14) can be split between the two controllers. In some embodiments, some of processes (1)-(14) are performed at a location that is remote from the well site, such as an office building or a laboratory.

The term “controller” should not be construed to limit the embodiments disclosed herein to any particular device type or system. The controller may include a computer system. The computer system may also include a computer processor (e.g., a microprocessor, microcontroller, digital signal processor, or general purpose computer) for executing any of the methods and processes described above (e.g., processes (1)-(14)).

The computer system may further include a memory such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. This memory may be used to store, for example, data from transmitted light signals, relative light signals, and output pressure signals.

Some of the methods and processes described above, including processes (1)-(14), as listed above, can be implemented as computer program logic for use with the computer processor. The computer program logic may be embodied in various forms, including a source code form or a computer executable form. Source code may include a series of computer program instructions in a variety of programming languages (e.g., an object code, an assembly language, or a high-level language such as C, C++, or JAVA). Such computer instructions can be stored in a non-transitory computer readable medium (e.g., memory) and executed by the computer processor. The computer instructions may be distributed in any form as a removable storage medium with accompanying printed or electronic documentation (e.g., shrink wrapped software), preloaded with a computer system (e.g., on system ROM or fixed disk), or distributed from a server or electronic bulletin board over a communication system (e.g., the Internet or World Wide Web).

The controller may include discrete electronic components coupled to a printed circuit board, integrated circuitry (e.g., Application Specific Integrated Circuits (ASIC)), and/or programmable logic devices (e.g., a Field Programmable Gate Arrays (FPGA)). Any of the methods and processes described above can be implemented using such logic devices.

Illustrative embodiments of the present disclosure are not limited to wireline logging operations, such as the ones shown in FIGS. 1 and 2. For example, the embodiments described herein can also be used with any suitable means of conveyance, such coiled tubing. Furthermore, various embodiments of the present disclosure may also be applied in logging-while-drilling (LWD) operations, sampling-while-drilling operations, measuring-while-drilling operations, or any other operation where sampling of the formation is performed.

Also, the methods and systems described herein are not limited to analyzing a set of particular fluids. Various embodiments of methods and systems described herein can be used to analyze hydrocarbons (e.g., dark oils, heavy oils, volatile oils, and black oils).

Moreover, although some examples and components are described herein as directed to microfluidic applications, the methods and systems described herein may be applied to any suitable fluidic application, including applications that do not utilize microfluidics.

Furthermore, various embodiments of the present disclosure are not limited to oil and gas field applications. The methods and systems described herein can also be applied to, for example, petrochemical refining and chemical manufacturing.

Although several example embodiments have been described in detail above, those skilled in the art will readily appreciate that many modifications are possible in the example embodiments without materially departing from the scope of this disclosure. Moreover the features described herein may be provided in any combination. Accordingly, all such modifications are intended to be included within the scope of this disclosure.

What is claimed is:

1. A method for analyzing a fluid sample, the method comprising:
transmitting light through the fluid sample;
applying a series of thermal pulses to the fluid sample, wherein the series comprises a time interval between each thermal pulse;
detecting transmitted light using a light detector; and
determining, based on an intensity of the transmitted light corresponding to at least one time interval, at least one of (a) whether or not the fluid is flowing and (b) a rate at which the fluid is flowing.

2. The method of claim 1, further comprising:
determining a flow rate of the fluid based on the intensity of the transmitted light corresponding to at least one time interval.

3. The method of claim 2, further comprising:
conveying the fluid at a predetermined flow rate; and
performing a flow rate measurement calibration based on an intensity of the transmitted light when the fluid is conveyed at the predetermined flow rate.

4. The method of claim 3, wherein the fluid is conveyed at the predetermined flow rate by controlling a piston pump configured to at least one of (a) push the fluid from a cylinder of the piston pump and (b) pull the fluid into the cylinder of the piston pump.

5. The method of claim 1, wherein the determination of flow is based on a difference in amplitude of a signal corresponding to the transmitted light.

6. The method of claim 1, wherein the determination of flow is based on a relative light signal.

7. The method of claim 6, wherein the relative light signal is determined using (i) the intensity of the transmitted light corresponding to a pulse and (ii) a baseline intensity of the transmitted light corresponding to a time interval.

8. The method of claim 1, wherein the determination of flow is based on detected optical scattering of the light.

9. The method of claim 8, wherein the determination of flow is based on an inverse of an amplitude of the optical scattering of the light.

10. The method of claim 1, wherein the method is performed at least partially in a bore hole of an oil well.

11. The method of claim 1, wherein the fluid is comprised of crude oil.

12. The method of claim 1, further comprising distinguishing between bubble point and asphaltene onset pressure of the fluid using the intensity of the transmitted light corresponding to the at least one time interval.

13. The method of claim 1, wherein the application of the series of thermal pulses raises the time-averaged temperature of the fluid by 0.01° C. or less with respect to ambient temperature of the fluid.

14. A method for determining calibration for measurement of flow rate of a fluid sample, the method comprising:
applying a predetermined flow rate to the fluid sample;
transmitting light through the fluid sample;
applying a series of thermal pulses to the fluid sample while at the predetermined flow rate;
detecting transmitted light during the applying the series of thermal pulses to the fluid sample and at the predetermined flow rate; and
determining a calibration curve based on the detected transmitted light.

15. The method of claim 14, further comprising detecting the light at different predetermined flow rates to facilitate generation of the calibration curve.

16. A system for analyzing a fluid sample, the system comprising:
a light source configured to generate light that is transmitted through the fluid sample;
a detector configured to detect light generated by the light source;
a heating element configured to apply thermal pulses to the fluid sample; and
a controller configured to determine, based on an intensity of the transmitted light corresponding to at least one time interval between thermal pulses, at least one of (a) whether or not the fluid sample is flowing and (b) a rate at which the fluid sample is flowing.

17. The system of claim 16, wherein the controller is further configured to perform in situ calibration for flow rate measurement.

18. The system of claim 16, wherein the controller is further configured to determine a relative light signal.

19. The system of claim 16, wherein the controller is further configured to determine bubble point of the fluid sample using an intensity of the transmitted light corresponding to at least one time interval between thermal pulses.

20. The system of claim 16, wherein the controller is further configured to determine asphaltene onset pressure of the fluid sample using an intensity of the transmitted light corresponding to at least one time interval between thermal pulses.
